(19) United States
(12) Patent Application Publication
(10) Pub. No.: US 2016/0075280 A1
(43) Pub. Date: Mar. 17, 2016

(54) SYSTEM FOR ESTIMATING LANE AND METHOD THEREOF

(71) Applicant: HYUNDAI MOTOR COMPANY, Seoul (KR)

(72) Inventors: Ki Cheol SHIN, Seongnam-Si (KR); Eu Suk JUNG, Seoul (KR); Myung Seon HEO, Seoul (KR); Young Chul OH, Seongnam-Si (KR)

(21) Appl. No.: 14/563,836

(22) Filed: Dec. 8, 2014

(30) Foreign Application Priority Data
Sep. 12, 2014 (KR) 10-2014-0121251

(51) Int. Cl. B60R 1/00

(52) U.S. Cl. CPC B60R 1/00; B60R 2300/10; B60R 2300/804

(57) ABSTRACT

A system for estimating a lane includes a vehicle information collector configured to receive coordinate information of surrounding vehicles and vehicle information; a surrounding vehicle tracker configured to track the surrounding vehicles; an own vehicle behavior calculator configured to calculate behavior information of an own vehicle by calculating a change in a location and a change in a heading angle of the own vehicle and generate coordinate history information of the surrounding vehicles using the behavior information of the own vehicle; a driving trajectory restorer configured to restore driving trajectories of the surrounding vehicles by applying the coordinate history information to a curve fitting technique; and a lane estimator configured to estimate the lane using the restored driving trajectories.

### CROSS-REFERENCE TO RELATED APPLICATION

This application is based on and claims the benefit of priority to Korean Patent Application No. 10-2014-0121251, filed on Sep. 12, 2014 in the Korean Intellectual Property Office, the disclosure of which is incorporated herein in its entirety by reference.

### TECHNICAL FIELD

The present disclosure relates to a system for estimating a lane and a method thereof, and more particularly, to a technology for estimating a lane shape by restoring trajectories of surrounding vehicles (left, right, and front vehicles).

### BACKGROUND

As a function of a vehicle has become sophisticated, vehicles having various safety systems have been introduced. Examples of these safety systems, which are systems for sensing accidents which may occur on driving or during parking using a variety of sensors, vision systems, and laser systems, and then warning a driver or controlling the vehicle, may include an electric stability program (ESP), an adaptive cruise control (ACC), a lane keeping assist System (LKAS), a lane departure warning system (LDWS), and the like.

The above-mentioned safety systems basically recognize a lane and provide services such as keeping a distance between vehicles, keeping the lane, and the like based on the recognized lane. Consequently, a technology for directly recognizing the lane using cameras to recognize the lane has been used.

However, in the case in which the lane is directly recognized using image sensors (for example, cameras) as in the W related art, a distance between a front vehicle and an own vehicle becomes very short and the front vehicle blocks a view of a marking portion of the lane in a traffic congestion section, such that instances in which the lane recognition fails or the lane is erroneously recognized have frequently occurred.

The above-mentioned erroneous recognition or non-recognition of the lane may degrade reliability of a lane-recognition-based vehicle safety system and may increase danger of a vehicle driving.

### SUMMARY

The present disclosure has been made to solve the above-mentioned problems occurring in the prior art while advantages achieved by the prior art are maintained intact.

An aspect of the present disclosure provides a system for estimating a lane and a method thereof enabling a safe drive of a driver by accurately estimating the lane and providing the estimated lane to the driver by restoring driving trajectories of surrounding vehicles in a situation in which the driver may not directly recognize the lane.

According to an exemplary embodiment of the present disclosure, a system for estimating a lane includes: a vehicle information collector configured to receive coordinate information of surrounding vehicles and vehicle information; a surrounding vehicle tracker configured to track the surrounding vehicles; an own vehicle behavior calculator configured to calculate behavior information of an own vehicle by calculating a change in a location and a change in a heading angle of the own vehicle and generate coordinate history information of the surrounding vehicles using the behavior information of the own vehicle; a driving trajectory restorer configured to restore driving trajectories of the surrounding vehicles by applying the coordinate history information to a curve fitting technique; and a lane estimator configured to estimate the lane using the restored driving trajectories.

According to another exemplary embodiment of the present disclosure, a method for estimating a lane includes: receiving coordinate information of surrounding vehicles from a distance sensing device; tracking the surrounding vehicles; receiving vehicle information from a vehicle device; calculating behavior information of an own vehicle by calculating a change in a location and a change in a heading angle of the own vehicle and generating coordinate history information of the surrounding vehicles using the behavior information of the own vehicle; restoring driving trajectories of the surrounding vehicles by applying the coordinate history information to a curve fitting technique; and estimating the lane using the restored driving trajectories.

### BRIEF DESCRIPTION OF THE DRAWINGS

The above and other objects, features and advantages of the present disclosure will be more apparent from the following detailed description taken in conjunction with the accompanying drawings.

FIG. 1 is a configuration diagram of a system for estimating a lane according to an exemplary embodiment of the present disclosure.

FIG. 2 is a diagram illustrating a method for estimating a lane according to an exemplary embodiment of the present disclosure.

FIG. 3 is a diagram illustrating tracking of surrounding vehicles by acquiring sensor information according to an exemplary embodiment of the present disclosure.

FIG. 4 is an illustrative diagram illustrating a method for calculating a behavior of an own vehicle according to an exemplary embodiment of the present disclosure.

FIG. 5 is a diagram illustrating calculating coordinate history information of the surrounding vehicles according to an exemplary embodiment of the present disclosure.

FIG. 6 is a diagram illustrating restoring driving trajectories utilizing a curve fitting technique according to an exemplary embodiment of the present disclosure.

FIG. 7 is a diagram illustrating estimating the lane using the restored driving trajectories according to an exemplary embodiment of the present disclosure.

FIG. 8 is a diagram illustrating estimating a distance between the own vehicle and left and right lanes according to an exemplary embodiment of the present disclosure.

FIG. 9 is a diagram illustrating non-recognized or erroneously recognized lane and the restored driving trajectories according to an exemplary embodiment of the present disclosure.

FIG. 10 is a diagram illustrating displaying an estimated lane according to an exemplary embodiment of the present disclosure.

FIG. 11 is a configuration diagram illustrating a computing system to which the method for estimating the lane according to the exemplary embodiment of the present disclosure may be applied.

### DETAILED DESCRIPTION

Hereinafter, the most preferred exemplary embodiments of the present disclosure will be described in detail with reference to the accompanying drawings so that those skilled in the art may easily implement the spirit of the present invention.

The present disclosure discloses a technology for tracking surrounding vehicles which are recognized every hour, obtaining coordinate information of the surrounding vehicles, updating previously measured data with a sensor coordinate system of a current own vehicle position using a behavior model of the own vehicle to store a coordinate history for each surrounding vehicle, restoring driving trajectories of the surrounding vehicles by applying coordinate history information to a curve fitting technique, and estimating a lane shape utilizing the restored driving trajectories.

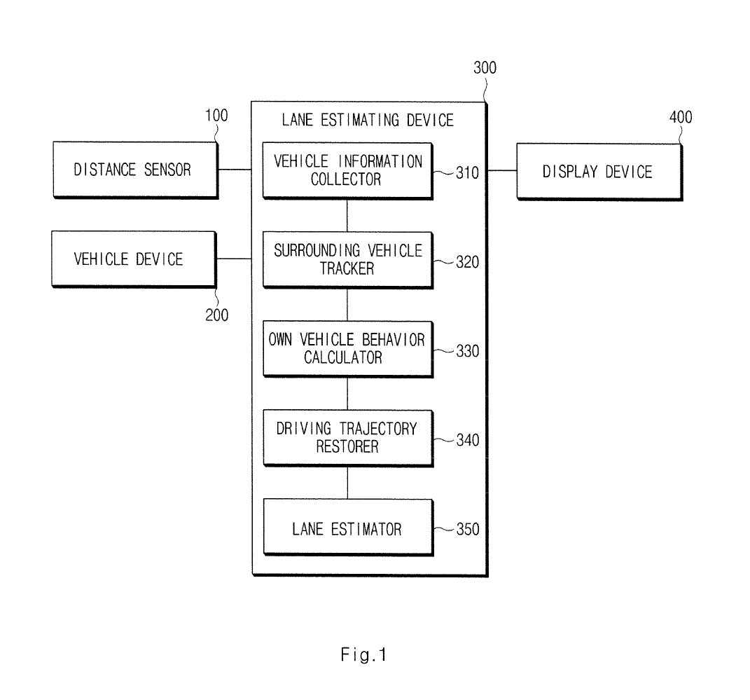

Hereinafter, exemplary embodiments of the present disclosure will be described in detail with reference to FIGS. 1 to 11.

FIG. 1 is a configuration diagram illustrating a system for estimating a lane according to an exemplary embodiment of the present disclosure.

The system for estimating the lane according to the exemplary embodiment of the present disclosure includes a distance sensor 100, a vehicle device 200, a lane estimating device 300, and a display device 400.

The distance sensor 100 senses coordinates of surrounding vehicles and provides coordinate information of the surrounding vehicles to the lane estimating device 300. In this case, the distance sensing device 100 may include a lidar, and the like. The coordinate information of the surrounding vehicles sensed by the distance sensor 100 may be obtained as (x, y) coordinates based on a center of a sensor coordinate system in a two-dimensional plane.

The vehicle device 200, which includes a transmission, provides vehicle information such as velocity (v) information and yaw rate (ψ) information, and the like of an own vehicle to the lane estimating device 300.

The lane estimating device 300 calculates the coordinate history information of the surrounding vehicles by tracking the coordinate information of the surrounding vehicles, restores the driving trajectories of the surrounding vehicles by calculating an own vehicle behavior and applying the coordinate history information of the surrounding vehicles and own vehicle behavior information to the curve fitting technique, and estimates the lane using the restored driving trajectories.

To this end, the lane estimating device 300 includes a vehicle information collector 310, a surrounding vehicle tracker 320, an own vehicle behavior calculator 330, a driving trajectory restorer 340, and a lane estimator 350.

The vehicle information collector 310 receives location information (coordinate information) of the surrounding vehicles from the distance sensor 100 and receives vehicle information such as the vehicle velocity information, the yaw rate information, and the like from the vehicle device 200.

The surrounding vehicle tracker 320 tracks motions of the surrounding vehicles and matches a corresponding object to a measured coordinate. That is, the object (surrounding vehicle) tracking means that an object which was measured in a previous measurement is tracked so as to be classified into the same object as a current measurement.

The own vehicle behavior calculator 330 calculates a change in a location and a change in a heading angle utilizing the velocity and yaw rate of the vehicle and calculates a behavior of the own vehicle to convert a measured coordinate history over the time of the same object into a sensor coordinate system of a current time. That is, the own vehicle behavior calculator 330 converts coordinate information of the surrounding vehicles into the sensor coordinate system of a current location and generates history information.

The driving trajectory restorer 340 restores driving trajectories by utilizing the curve fitting technique to the coordinate history of objects which are currently represented in the sensor coordinate system.

The lane estimator 350 estimates the lane using curvatures and representative values of angles of the restored driving trajectories of the surrounding vehicles and offset information of driving trajectories which are closest to left and right of the own vehicle. In addition, the lane estimator 350 estimates distances between the own vehicle and left and right lanes using the restored trajectories of left and right driving vehicles.

The display device 400 allows a driver to check lane information by displaying the lane information estimated by the lane estimating device 300 on a screen. In this case, the display device 400 may include all displayable terminals in the vehicle such as a navigation terminal, a telematics terminal, an audio, video, and navigation terminal, and the like.

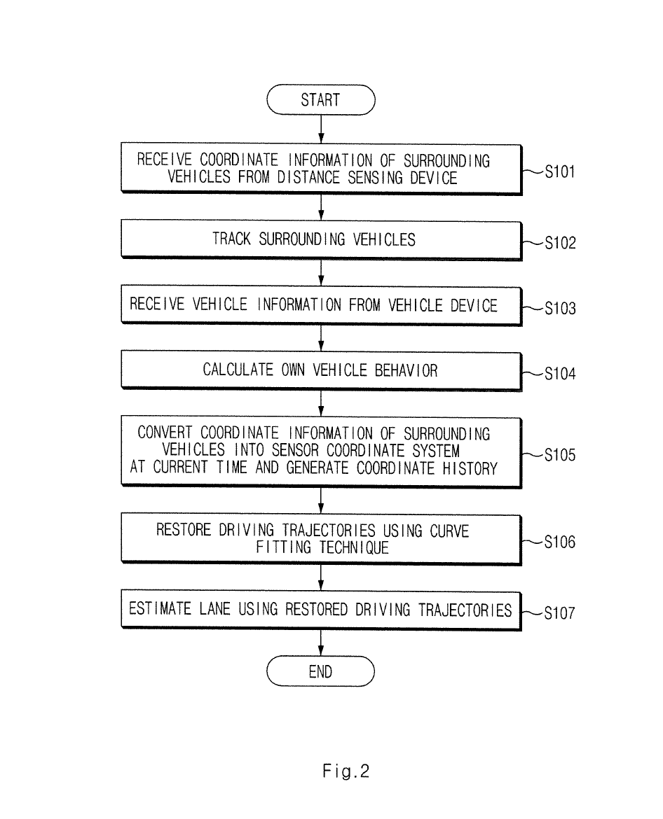

Hereinafter, a method for estimating a lane by restoring the driving trajectories of the surrounding vehicle will be described in detail with reference to FIG. 2.

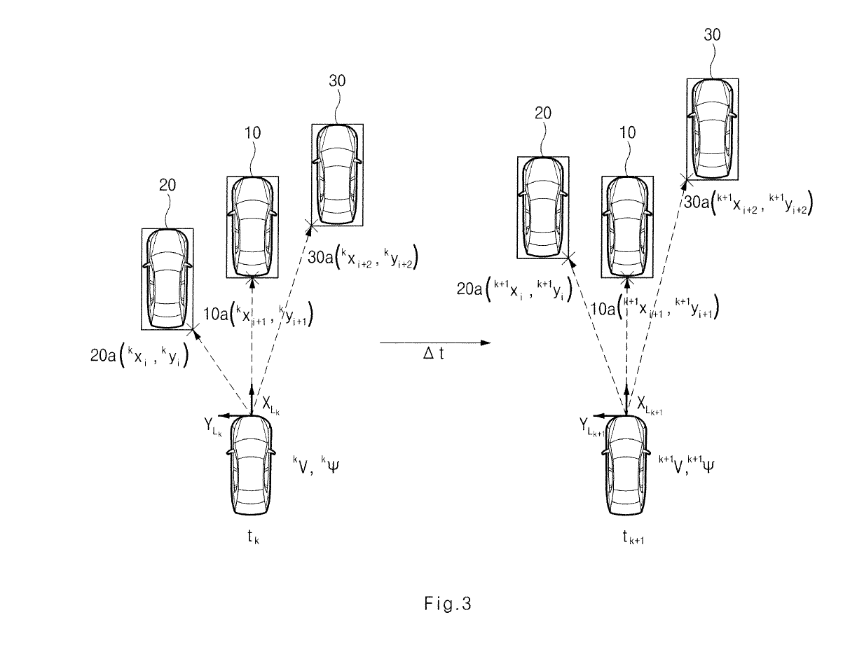

First, the vehicle information collector 310 receives coordinate information of the surrounding vehicles from the distance sensor 100 (S101). In this case, the distance sensor 100 may be a lidar, and the coordinate information of the surrounding vehicles sensed by the distance sensor 100 may be obtained as (x, y) coordinates based on a center of a sensor coordinate system in a two-dimensional plane. In this case, referring to FIG. 3, the coordinate information of the surrounding vehicles uses a center point 10a of a front vehicle 10, a left end point 20a of a left moving vehicle 20, and a left end point 30a of a right moving vehicle 30. The coordinate system represents a coordinate of an object (surrounding vehicle) recognized for a coordinate system (X_{L}_{ₖ}, Y_{L}_{ₖ}) of a sensor at a time tₖ, as (^{k}xᵢ,^{k}yᵢ).

Next, the surrounding vehicle tracker 320 tracks motions of the surrounding vehicles (S102). Referring to FIG. 3, the surrounding vehicle tracker 320 performs an object tracking which tracks that the object i measured at the time tₖ is the same object as the object i measured at a time tₖ+1 using the object tracking and matches the object i measured at the time tₖ to the object i measured at the time of tₖ+1.

Next, the vehicle information collector 310 receives vehicle information such as velocity (v) and yaw rate (w) information of the own vehicle from the vehicle device 200 such as the transmission in the vehicle (S103).

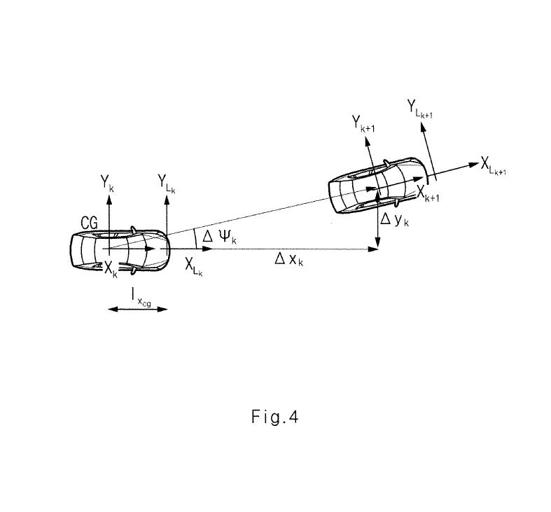

Next, the own vehicle behavior calculator 330 calculates behavior information ((Δxₖ,Δyₖ),Δψₖ) of the own vehicle for a coordinate system of a previous time utilizing a behavior model of the own vehicle (S104). Referring to FIG. 4, the own vehicle behavior calculator 330 calculates a change in a location (Δxₖ,Δuyₖ) and a change in a heading angel (Δψₖ) because the own vehicle moves from a location at the time tₖ to a location at the time tₖ+1. In this case, the change in the location and the change in the heading angle may be calculated by utilizing a sampling time of the sensor, and the velocity and yaw rate of the vehicle. In the present exemplary embodiment, the change in the location and the change in the heading angle are represented based on a barycentric coordinate system (X_{L}_{ₖ},Y_{L}_{ₖ}) at the time tₖ. That is, the own vehicle behavior calculator 330 calculates the change in the location (Δxₖ,Δyₖ) and the change in the heading angle (Δψₖ) utilizing the velocity and yaw rate of the vehicle.

Next, the own vehicle behavior calculator 330 converts coordinate information ((^{k}xᵢ,^{k}yᵢ,(^{k}xᵢ₊₁,^{k}yᵢ₊₁),(^{k}xᵢ₊₂,^{k}yᵢ₊₂)) of the surrounding vehicles into the sensor coordinate system of a current location and generates coordinate history information (S105).

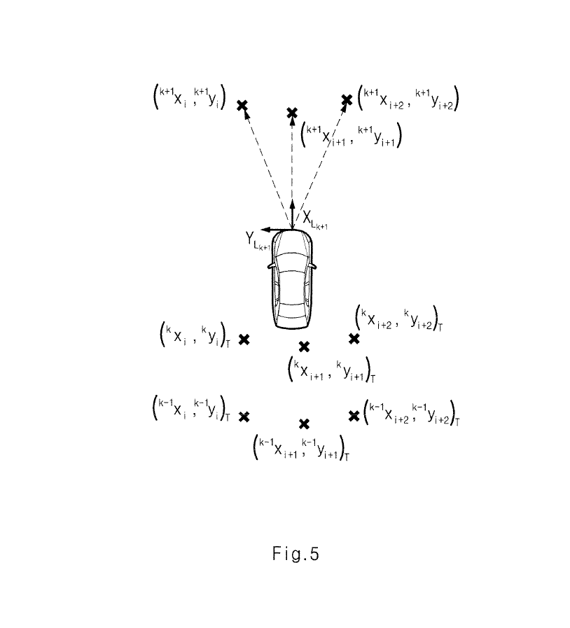

That is, referring to FIG. 5, the own vehicle behavior calculator 330 converts coordinate data ((^{k}xᵢ,^{k}yᵢ,(^{k}xᵢ₊₁,^{k}yᵢ₊₁),(^{k}xᵢ₊₂,^{k}yᵢ₊₂)) of the surrounding objects (vehicles) which were measured for the sensor coordinate system (X_{L}_{ₖ},Y_{L}_{ₖ}) at the previous time using the previously calculated behavior of the own vehicle into a sensor coordinate system (X_{L}_{ₖ₊₁}, Y_{L}_{ₖ₊₁}) of the current time, and obtains coordinates ((^{k}xᵢ,^{k}yᵢ)_{T}, (^{k}xᵢ₊₁,^{k}yᵢ₊₁)_{T}, (^{k}xᵢ₊₂,^{k}yᵢ₊₂)_{T}). In the case in which the above-mentioned processes are continuously performed and the converted coordinates are accumulated over time, the coordinate histories for the respective surrounding vehicles may be generated. The histories (hᵢ, hᵢ₊₁, hᵢ₊₂) of the surrounding vehicles may be represented by the following Equation 1.

hᵢ={(^{k+1}xᵢ,^{k+1}yᵢ),(^{k}xᵢ,^{k}yᵢ)_{T},(^{k-1}xᵢ,^{k-1}yᵢ)_{T}, . . . }

hᵢ₊₁={(^{k+1}xᵢ₊₁,^{k+1}yᵢ₊₁),(^{k}xᵢ₊₁,^{k}yᵢ₊₁)_{T},(^{k-1}xᵢ₊₁,^{k-1}yᵢ₊₁)_{T}, . . . }

hᵢ₊₂={(^{k+1}xᵢ₊₂,^{k+1}yᵢ₊₂),(^{k}x_{i'2},^{k}yᵢ₊₂)_{T},(^{k-1}xᵢ₊₂,^{k-1}yᵢ₊₂)_{T}, . . . } [Equation 1]

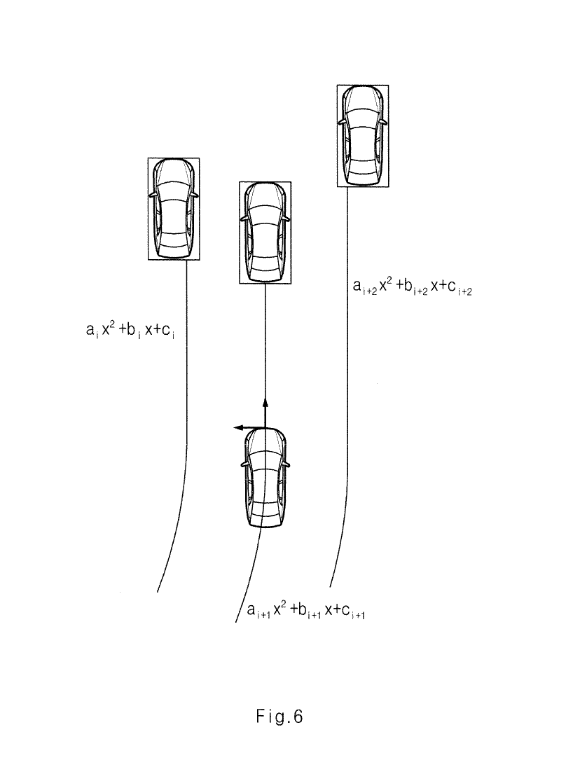

Next, the driving trajectory restorer 340 restores the driving trajectories of the surrounding vehicles using the curve fitting technique (S106). That is, the driving trajectory restorer 340 may restore the driving trajectories utilizing the curve fitting technique for the coordinate histories (hᵢ, h₁₊₁, h₁₊₂) which are generated as illustrated in FIG. 6. In this case, a relationship equation fitting n (x, y) coordinate data with a quadratic curve is represented by the following Equation 2.

$$[ \begin{matrix}{a}_{0} \\ {a}_{1} \\ {a}_{2}\end{matrix} ] = [ \begin{matrix}n & {\sum }_{j = 0}^{n} {x}_{j} & {\sum }_{j = 0}^{n} {( {x}_{j} )}^{2} \\ {\sum }_{j = 0}^{n} {x}_{j} & {\sum }_{j = 0}^{n} {( {x}_{j} )}^{2} & {\sum }_{j = 0}^{n} {( {x}_{j} )}^{3} \\ {\sum }_{j = 0}^{n} {( {x}_{j} )}^{2} & {\sum }_{j = 0}^{n} {( {x}_{j} )}^{3} & {\sum }_{j = 0}^{n} {( {x}_{j} )}^{4}\end{matrix} ] [ \begin{matrix}{\sum }_{j = 0}^{n} {y}_{j} \\ {\sum }_{j = 0}^{n} {x}_{j} {y}_{j} \\ {\sum }_{j = 0}^{n} {( {x}_{j} )}^{2} {y}_{j}\end{matrix} ] . \qquad [ Equation 2 ]$$

The driving trajectories as illustrated in FIG. 6 may be restored by calculating coefficients of curves obtained by applying the curve fitting technique of a second-order polynomial form to the respective coordinate histories such as R) the following Equation 3 using Equations 1 and 2. [Equation 3]

pᵢ={aᵢ,bᵢ,cᵢ}

pᵢ₊₁={aᵢ₊₁,bᵢ₊₁,cᵢ₊₁}

pᵢ₊₂={aᵢ₊₂,bᵢ₊₂,cᵢ₊₂}

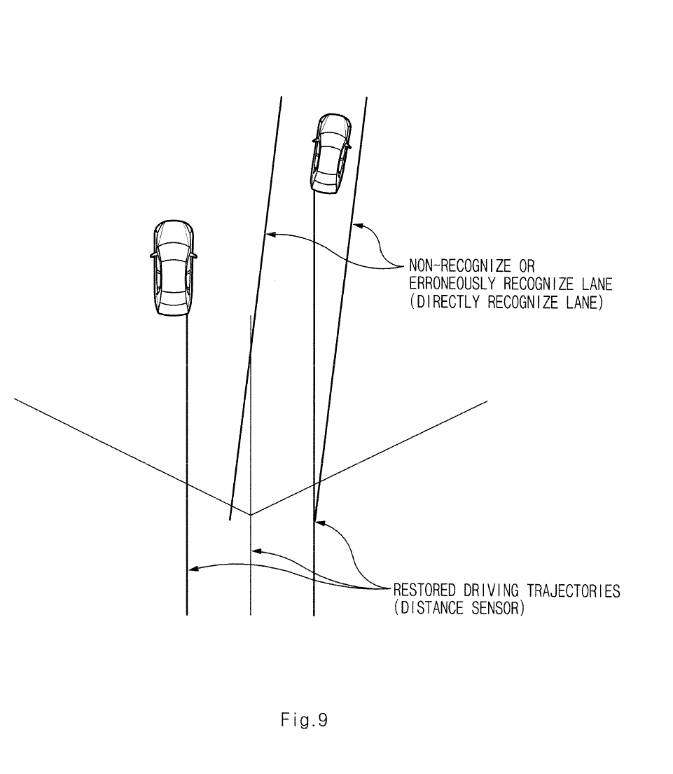

For reference, FIG. 9 is a diagram illustrating an example in which the driving trajectory of the surrounding vehicle is restored using the distance sensor 100, in the case in which the lane is not recognized or is erroneously recognized by the camera.

Next, the lane estimator 350 estimates a form of the lane using curvatures and representative values of angles of the restored fitting curves and offsets from the own vehicle to trajectories of the left and right vehicles (S107).

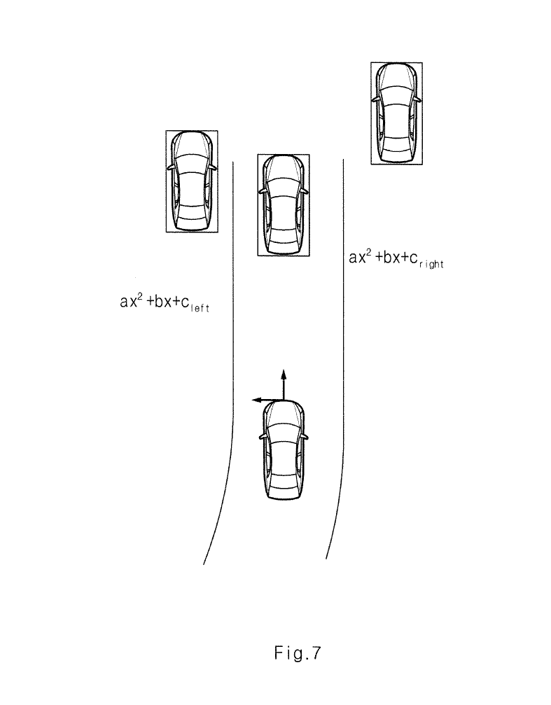

That is, the lane estimator 350 estimates a curvature (a/2) of the lane and an included angle (b) between a heading angle of the own vehicle and the lane as illustrated in FIG. 7 using the driving trajectories restored in FIG. 6. In this case, the estimation of the curvature and the included angle M between the heading angle of the own vehicle and the lane may be performed using the representative values of the restored driving trajectories.

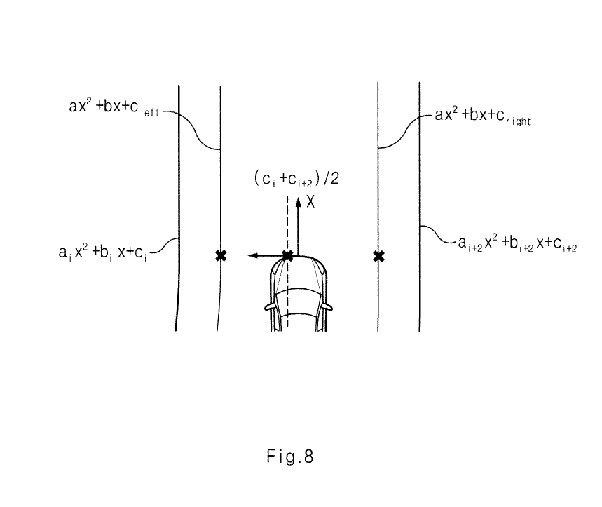

In addition, the lane estimator 350 estimates offsets (c_{left}, c_{right}) from the own vehicle to the left and right lanes using the restored trajectories of the left and right driving vehicles as illustrated in FIG. 8 and estimates a distance up to left and right of the lane using offsets up to the left and right driving vehicles.

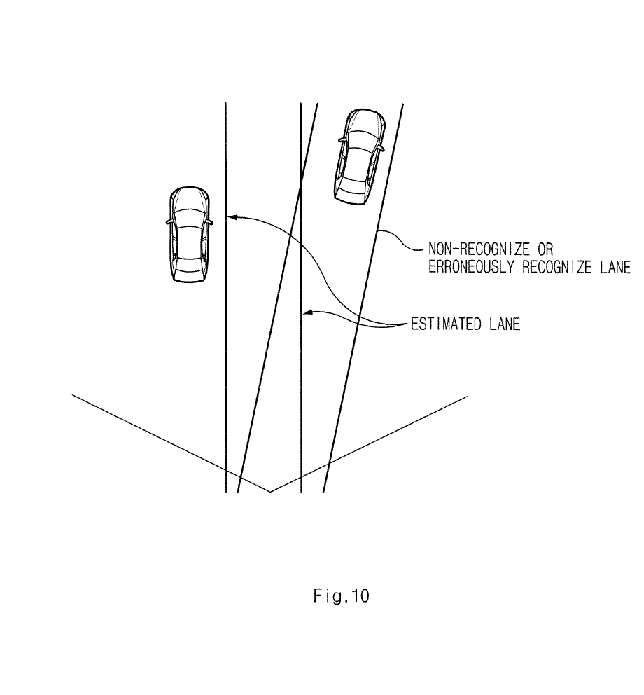

For example, according to the present exemplary embodiment, since an i+2-th vehicle drives on the right and an i-th vehicle drives on the left, a center of two driving trajectories becomes (0.5(cᵢ+cᵢ₊₂)), and 0.5(cᵢ+cᵢ₊₂)+0.5wₗₐₙₑ may be estimated as a left offset of the lane and 0.5(cᵢ+cᵢ₊₂)−0.5wₗₐₙₑ may be estimated as a right offset of the lane using a driving lane width (wₗₐₙₑ) based on the center. However, in the case in which the vehicle does not drive on the other lane, it is possible to utilize only a driving trajectory of the vehicle which drives on one lane by limiting a maximum value of the lane width. In addition, in the case in which the vehicles do not drive on both lanes, it may be assumed that a preceding vehicle drives on the center of the lane. For reference, FIG. 10 is a diagram illustrating an example in which a real lane is estimated by restoring the driving trajectories of the surrounding vehicles using the distance sensor 100, in the case in which the lane is not recognized or is erroneously recognized by the camera.

As described above, according to the present disclosure, the lane may be accurately estimated only using the distance sensor (lidar, or the like) without using the image sensor (camera) even in the case in which the lane recognition is impossible such as the congestion section, the case in which the lane marking is not present or is erased, or the like. In addition, a safe drive of the driver is enabled by providing accurate lane information to a vehicle safe driving related system such as a lane keeping system, or the like.

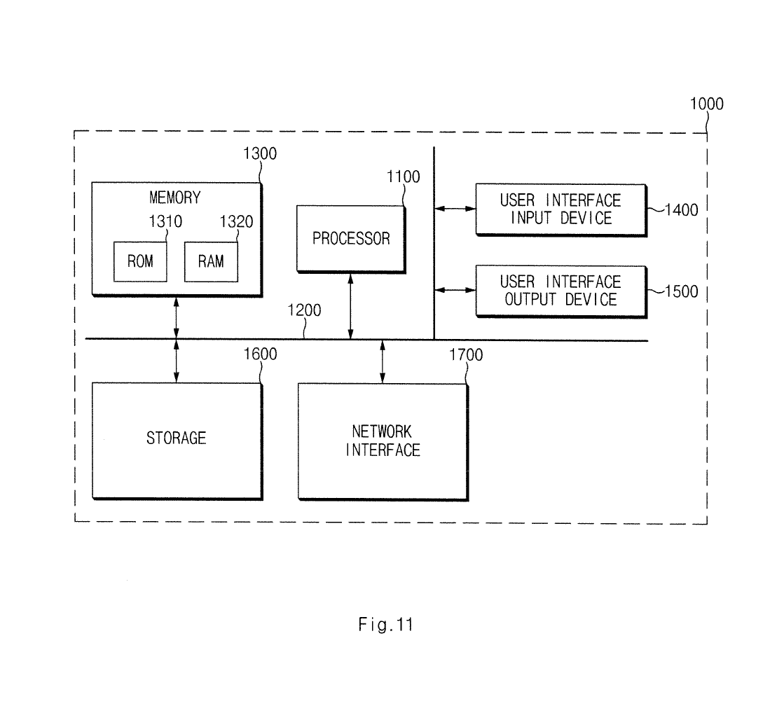

Referring to FIG. 11, a computing system 1000 may include at least one processor 1100, a memory 1300, a user interface input device 1400, a user interface output device 1500, a storage 1600, and a network interface 1700 which are connected through a bus 1200.

The processor 1100 may be a central processing unit (CPU) or a semiconductor device performing processes for instructions which are stored in the memory 1300 and/or the storage 1600. The memory 1300 and the storage 1600 may include various kinds of volatile or non-volatile storing media. For example, the memory 1300 may include a read only memory (ROM) and a random access memory (RAM).

Accordingly, steps in the method or algorithm which is described in context with the exemplary embodiments disclosed in the present specification may be directly implemented in hardware, a software module, or a combination thereof which is executed by the processor 1100. The software module may be resided on a storing medium (i.e., the memory 1300 and/or the storage 1600) such as a RAM memory, a flash memory, a ROM memory, an erasable programmable read only memory (EPROM) memory, an electrically erasable programmable read only memory (EEPROM) memory, a register, a hard disk, a removable disk, or a compact disc-read only memory (CD-ROM). An exemplary storing medium may be coupled to the processor 1100 and the processor 1100 may read information from the storing medium and write the information into the storing medium. Alternatively, the storing medium may be integral with the processor 1100. The processor and the storing medium may be resided within an application specific integrated circuit (ASIC). The ASIC may be resided within a user terminal. Alternatively, the processor and the storing medium may be resided within the user terminal as an individual component.

As described above, the present technology enables the safe drive of the driver by accurately estimating the lane and providing the estimated lane to the driver only using the distance sensor (lidar, or the like) without using the image sensor (camera) in the case in which the lane recognition is impossible such as the congestion section, the case in which the lane marking is not present or is erased, or the like.

The exemplary embodiments of the present disclosure described above have been provided for illustrative purposes. Therefore, those skilled in the art will appreciate that various modifications, alterations, substitutions, and additions are possible without departing from the scope and spirit of the disclosure as disclosed in the accompanying claims and such modifications, alterations, substitutions, and additions fall within the scope of the present disclosure.

What is claimed is:

1. A system for estimating a lane, the system comprising:
a vehicle information collector configured to receive coordinate information of surrounding vehicles and vehicle information;
a surrounding vehicle tracker configured to track the surrounding vehicles;
an own vehicle behavior calculator configured to calculate behavior information of an own vehicle by calculating a change in a location and a change in a heading angle of the own vehicle and generate coordinate history information of the surrounding vehicles using the behavior information of the own vehicle;
a driving trajectory restorer configured to restore driving trajectories of the surrounding vehicles by applying the coordinate history information to a curve fitting technique; and
a lane estimator configured to estimate the lane using the restored driving trajectories.

2. The system according to claim 1, further comprising a distance sensor configured to sense locations of the surrounding vehicles and transmit coordinate information of the surrounding vehicles to the vehicle information collector.

3. The system according to claim 2, wherein the distance sensor includes a lidar.

4. The system according to claim 2, wherein the own vehicle behavior calculator calculates the change in the location and the change in the heading angle of the own vehicle using a sampling time of the distance sensor, velocity of a vehicle, and yaw rate information of the vehicle.

5. The system according to claim 2, wherein the surrounding vehicle tracker converts the coordinate information of the distance sensor into an object coordinate.

6. The system according to claim 5, wherein the own vehicle behavior calculator converts the coordinate information of the surrounding vehicles which is converted into the object coordinate into a sensor coordinate system of a current time and then accumulates it during a predetermined time to thereby generate the coordinate history information of the surrounding vehicles.

7. The system according to claim 3, wherein the lane estimator estimates a curvature of the lane and an included angle between the heading angle of the own vehicle and the lane from the restored driving trajectories and estimates distances between the own vehicle and left and right lanes.

8. A method for estimating a lane, the method comprising steps of:
receiving coordinate information of surrounding vehicles from a distance sensor;
tracking the surrounding vehicles;
receiving vehicle information from a vehicle device;
calculating behavior information of an own vehicle by calculating a change in a location and a change in a heading angle of the own vehicle and generating coordinate history information of the surrounding vehicles using the behavior information of the own vehicle;
restoring driving trajectories of the surrounding vehicles by applying the coordinate history information to a curve fitting technique; and
estimating the lane using the restored driving trajectories.

9. The method according to claim 8, wherein in the step of generating the coordinate history information of the surrounding vehicles, the behavior information of the own vehicle is calculated by calculating the change in the location and the change in the heading angle of the own vehicle using a sampling time of the distance sensor, velocity of a vehicle, and yaw rate information of the vehicle.

10. The method according to claim 8, wherein in the step of estimating the lane, a curvature of the lane and an included angle between the heading angle of the own vehicle and the lane are estimated from the restored driving trajectories and distances between the own vehicle and left and right lanes are estimated.
